(19) United States
(12) Patent Application Publication
(10) Pub. No.: US 2017/0123713 A1
(43) Pub. Date: May 4, 2017

(54) DEVICE AND PROCESS FOR DATA STORAGE AND READ/WRITE EFFICIENCY

(71) Applicant: IMAGINE COMMUNICATIONS CORP., Frisco, TX (US)

(72) Inventors: Yuval FISHER, Sunnyvale, CA (US); Ron GUTMAN, San Diego, CA (US)

(21) Appl. No.: 14/927,966

(22) Filed: Oct. 30, 2015

(51) Int. Cl. G06F 3/06

(52) U.S. Cl. CPC G06F 3/0643; G06F 3/0604; G06F 3/064; G06F 3/067

(57) ABSTRACT

Adaptive Bitrate (ABR) HTTP streaming protocols allow for video streaming at client devices. Embodiments relate to a storage controller configured for efficient memory usage for storage and throughput. The storage controller concatenates file segments to a number of contiguous physical storage blocks and updates a manifest file with offset values as pointers to the contiguous physical storage blocks for video streaming to client devices.

### FIELD

The embodiments disclosed herein generally relate to the field of data storage and streaming multimedia over computer networks.

### INTRODUCTION

Memory or storage devices are often used in a wide range of technologies, such as in computer systems, to store data. For example, non-volatile memory devices may be used for auxiliary or secondary memory in a computer system to store digital data. Such non-volatile memory may include block storage devices. A block storage device, such as for example disk storage, tape storage, or flash memory (e.g. NAND flash memory), utilizes contiguous sequences of bytes as quanta of storage that are read and written from the devices together as a whole. The typical size of a physical block of memory varies depending on the storage device itself as well as on the system within which it is being used. A physical block may store, for example, anywhere from 512 bytes to 512 KB of data. Such block storage devices may be susceptible to internal fragmentation, which is a storage inefficiency that occurs when a complete block of storage is used to hold less than the amount of data that may be stored by a block of storage. Another inefficiency may occur in block storage devices, such as hard disks, in which fetch and store times of stored content depends on the physical location of the content on the device. In this case, when contiguous content is stored in physically distant blocks, both the write and read times may be longer than when the content is stored contiguously.

### SUMMARY

In accordance with one aspect, there is provided a storage system for adaptive bitrate video with at least one memory storage device containing a plurality of physical storage blocks storing video and audio content encoded into multiple profiles, each profile segmented into a plurality of original file segments as a first file. The storage system has a storage controller configured to: scan the at least one memory storage device to locate a number of initial physical storage blocks for the streaming video content; read the plurality of original file segments from the number of initial physical storage blocks; write the plurality of original file segments to a number of contiguous physical storage blocks to create a second file as a plurality of new file segments being a concatenation of the plurality of original file segments, each new file segment corresponding to an original file segment, the number of contiguous physical storage blocks being less than the number of initial physical storage blocks, and the number of contiguous physical storage blocks having less wasted memory space than the wasted memory space of the number of initial physical storage blocks; and write offset values for the plurality of new file segments to a manifest file stored on a server that links to the contiguous physical storage blocks. The storage system has a network interface connected to the storage controller to stream the video content using an adaptive bitrate protocol to a plurality of client devices using the plurality of new file segments and the manifest file. The storage controller controls the memory storage device to store the file segments on the physical storage blocks.

In some embodiments, the storage controller erases the plurality of original file segments of the first file from the one or more physical blocks.

In some embodiments, the first file is associated with the manifest file stored on the server, the manifest file having, for each of the plurality of original file segments, an initial pointer to the respective original file segment on an initial physical storage block of the number of initial physical storage blocks, and wherein the storage controller updates the manifest file with, for each new file segment of the second file, a byte offset value to update the initial pointer for the original file segment to the corresponding respective new file segment.

In some embodiments, the second file is a video or audio file, and the new file segments are physically stored in such a way that the video or audio file is played back by sequentially accessing the one or more contiguous blocks.

In some embodiments, the storage controller writes the plurality of original file segments to create a second file by: writing a first file segment on one or more physical blocks; obtaining corresponding memory address of a first block on which the first file segment is stored; determining or obtaining the memory address at which to write the next file segment, based on a byte offset value; and writing the next file segment at the determined memory address.

In some embodiments, the storage controller determines the byte offset value based on a file size of an adjacent file segment.

In some embodiments, the memory address at which to write the next file segment is a virtual memory address or a physical memory address.

In another aspect, there is provided a process for optimizing memory storage efficiency of data, comprising executing on a processor the steps of: scanning at least one memory storage device containing a plurality of physical blocks to locate a number of initial physical storage blocks of the plurality of physical storage storing a plurality of original file segments belonging to a first file, the first file for adaptive bitrate video the number of initial physical storage blocks having wasted memory space; reading the plurality of original file segments from the number of initial physical storage blocks; writing the plurality of original file segments to a number of contiguous physical storage blocks of the plurality of physical blocks on the at least memory storage device to create a second file, the second file a plurality of new file segments being a concatenation of the plurality of original file segments, each new file segment corresponding to an original file segment, the number of contiguous physical storage blocks being less than the number of initial physical storage blocks, and the number of contiguous physical storage blocks having less wasted memory space than the wasted memory space of the number of initial physical storage blocks; and streaming the video content using an adaptive bitrate protocol to a plurality of client devices using the plurality of new file segments and the manifest file.

In some embodiments, the method involves erasing the plurality of original file segments of the first file from the one or more physical blocks.

In some embodiments, the first file is associated with a manifest file stored on a server, the manifest file having, for each of the plurality of original file segments, an initial pointer to the respective original file segment on an initial physical storage block of the number of initial physical storage blocks, and the method further comprises updating the manifest file with, for each new file segment of the second file, a byte offset value to update the initial pointer for the original file segment to the corresponding respective new file segment.

In some embodiments, the second file is a video or audio file, and the new file segments are physically stored in such a way that the video or audio file is played back by sequentially accessing the one or more contiguous blocks.

In some embodiments, writing of the plurality of original file segments to create a second file comprises: writing a first file segment on one or more physical blocks; obtaining corresponding memory address of a first block on which the first file segment is stored; determining or obtaining the memory address at which to write the next file segment, based on a byte offset value; and writing the next file segment at the determined memory address.

In some embodiments, the byte offset value is determined based on a file size of the next file segment. In some embodiments, the memory address at which to write the next file segment is a virtual memory address or a physical memory address.

In another aspect, there is provided a storage controller configured to: access at least one memory storage device containing a plurality of physical storage blocks storing video and audio content encoded into multiple profiles, each profile segmented into a plurality of original file segments as a first file, scan the at least one memory storage device to locate a number of initial physical storage blocks for the streaming video content; read the plurality of original file segments from the number of initial physical storage blocks; write the plurality of original file segments to a number of contiguous physical storage blocks to create a second file as a plurality of new file segments being a concatenation of the plurality of original file segments, each new file segment corresponding to an original file segment, the number of contiguous physical storage blocks being less than the number of initial physical storage blocks, and the number of contiguous physical storage blocks having less wasted memory space than the wasted memory space of the number of initial physical storage blocks; and write offset values for the plurality of new file segments to a manifest file stored on a server that links to the contiguous physical storage blocks. The storage controller connects to a network interface to stream the video content using an adaptive bitrate protocol to a plurality of client devices using the plurality of new file segments and the manifest file.

In some embodiments, the storage controller is configured to erase the plurality of original file segments of the first file from the one or more physical blocks.

In some embodiments, the first file is associated with the manifest file stored on the server, the manifest file having, for each of the plurality of original file segments, an initial pointer to the respective original file segment on an initial physical storage block of the number of initial physical storage blocks, and wherein the storage controller updates the manifest file with, for each new file segment of the second file, a byte offset value to update the initial pointer for the original file segment to the corresponding respective new file segment.

In some embodiments, the second file is a video or audio file, and the new file segments are physically stored in such a way that the video or audio file is played back by sequentially accessing the one or more contiguous blocks.

In some embodiments, the storage controller writes the plurality of original file segments to create a second file by: writing a first file segment on one or more physical blocks; obtaining corresponding memory address of a first block on which the first file segment is stored; determining or obtaining the memory address at which to write the next file segment, based on a byte offset value; and writing the next file segment at the determined memory address.

In some embodiments, the storage controller is configured to determine the byte offset value based on a file size of an adjacent file segment.

In some embodiments, the memory address at which to write the next file segment is a virtual memory address or a physical memory address.

Many further features and combinations thereof concerning embodiments described herein will appear to those skilled in the art following a reading of the instant disclosure.

### DESCRIPTION OF THE FIGURES

In the Figures,

FIG. 1 shows a schematic diagram of an example architecture for video streaming and storage according to some embodiments;

FIG. 2A shows a schematic diagram of a computing device that may be used to implement the server of FIG. 1 according to some embodiments;

FIG. 2B shows a simplified block diagram of a primary memory controlled using memory controller according to some embodiments;

FIG. 3 illustrates a schematic diagram of a portion of a block storage device highlighting used and unused storage blocks according to some embodiments;

FIG. 4A illustrates another schematic diagram of a portion of a block storage device according to some embodiments;

FIG. 4B illustrates a schematic diagram of the portion of block storage device in FIG. 4A after data storage optimization according to some embodiments;

FIG. 4C illustrates a schematic diagram of the portion of block storage device in FIG. 4B after data storage optimization according to some embodiments;

FIG. 5 is a flow chart illustrating an example data storage optimization method that may be performed by the server in FIG. 1 or the memory controller of FIG. 2A according to some embodiments;

FIG. 6 is a flow chart illustrating an example data writing routine that may be performed by the server in FIG. 1 as part of the data storage optimization method, exemplary of an embodiment; and

FIG. 7 illustrates an example video and audio ABR table with data storage efficiency factors, exemplary of an embodiment.

### DETAILED DESCRIPTION

The embodiments described herein relate to systems, methods and devices to increase the storage and read/write efficiency of storage of digital data on block storage devices. For example, embodiments described herein relate to a disk or storage controller for storing, reading and writing digital data to storage devices. The storage controller (or disk controller) may be a digital circuit that manages the flow of digital data going to and from the storage devices. A memory controller can be a separate circuit or integrated into another circuit, for example.

The embodiments described herein relate to systems, methods and devices for storage optimization of adaptive bitrate video and audio content. The systems, methods, and devices described herein may improve data storage efficiency and provide better memory usage in operating systems according to some embodiments.

The embodiments described herein relate to systems, methods and devices for storage optimization of read and write times due to reads being contiguous. Write times may be also be improved if the storage controller copies (e.g. read/write) content from one temporary (high-speed) storage (such as solid-state drives or SSD, for example) and then transfers large contiguous blocks to hard drives, for example. The storage controller may be referred to as a concatenator device or circuit according to some embodiments. The storage controller may provide a read efficiency due to the fact that its hard drive disk (HDD) reads may read more than just the requested data. The storage controller may read past the requested data and cache that content in fast memory, for example. If that data is accessed soon after, it is read from the cache, rather than from the hard drive. If the storage controller collects data into contiguous streams on disk, this may improve cache utilization and hence read throughput. The storage controller may also improve write speeds by aggregating the files into fast storage, such as SSDs, and then writing it out using the concatenator onto the HDD in large, contiguous blocks, thus minimizing disk head motion and hence improving write throughput. Accordingly, the storage controller and other devices or processes described herein may provide storage efficiency and read/write efficiency for block storage devices.

A block storage device, for example disk storage, tape storage, or NAND flash memory, can utilize contiguous sequences of bytes as quanta of storage that are read and written together as a whole. Typical size of a physical record or a physical block (also referred to as a “block” or “storage block”) of memory varies depending on the storage device itself as well as on the system within which it is being used. A single physical block may store a maximum of, for example, anywhere from 512 bytes to 512 KB of data; this maximum size of data storage capacity of a physical block may be referred to as a block size. Such storage devices may be susceptible to internal fragmentation, which is a storage inefficiency that occurs when a complete block of storage is used to hold less data than the block size. Where multiple files cannot be stored in the same block in a storage device, internal fragmentation can occur when a digital file being stored contains data that is smaller than the block size. It also occurs when storing a large file whose size is not an integral multiple of the block size, in which case, a remainder portion of the large file that is less than the block size requires an entire block for storing thereon.

### Data Storage in Adaptive Bitrate HTTP Streaming

Adaptive Bitrate (ABR) HTTP streaming protocols allow for seamless video streaming at client device despite varying network conditions. The protocols may break video and/or audio data into multiple sequences of short-duration file segments that are reassembled and played back at the client contiguously. For example, a single video content, or asset, may be encoded into multiple profiles. Each profile may be a complete video file (with or without accompanying audio track) of a different bitrate, and in turn of a different resolution, than the rest of the profiles. Each profile may be further divided or segmented into multiple contiguous file segments, where each segment may be a video clip that is two to ten seconds in length, for example. Typically, a single video content or asset consists of thousands of file segments, and in some cases, many millions of such video assets need to be stored on block storage devices, leading to significant inefficiencies due to internal fragmentation. For example, when a recording of live television streams is made at centralized locations in order to allow users to view content on-demand over a network connection (e.g. Cloud Digital Video Recorder “cDVR” use case), the resulting storage requirements can be high, especially when each user must store their own private copy of the video content.

The cDVR use case is one example of a situation where it may be desirable to store video content (e.g. ingested live content) as a sequence of many ABR files rather than as a small number of contiguous files. The multi-file approach allows individual copies for each user to be made within short time, per legal copyright requirements, and in a way that is resilient to failures. Because of this, users' private copies of assets may be typically stored as collections of many smaller files. For playback at the client (e.g. a user's tablet device or other computing device), as will be further described herein, a manifest file containing URIs referencing every file segment—whether audio, video, or both together—may be sent to the client device. The client device may be configured to fetch the individual file segments using HTTP, and play the file accordingly.

Embodiments described herein may provide systems, methods and devices for improving data storage and read/write efficiency on block storage devices, such as for ABR video streaming content as an illustrative example.

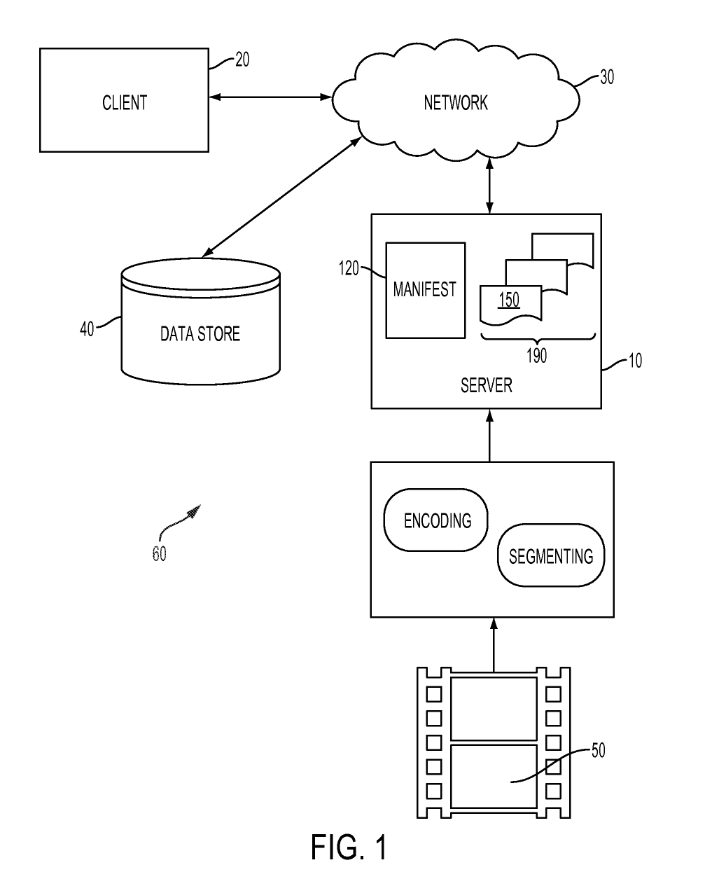

Referring now to FIG. 1, an exemplary schematic diagram of an example architecture 60 for VBR HTTP streaming is illustrated. A client device 20 is connected to a server 10 by network 30. A data store 40 may be connected to the server 10 and the client 20 via network 30.

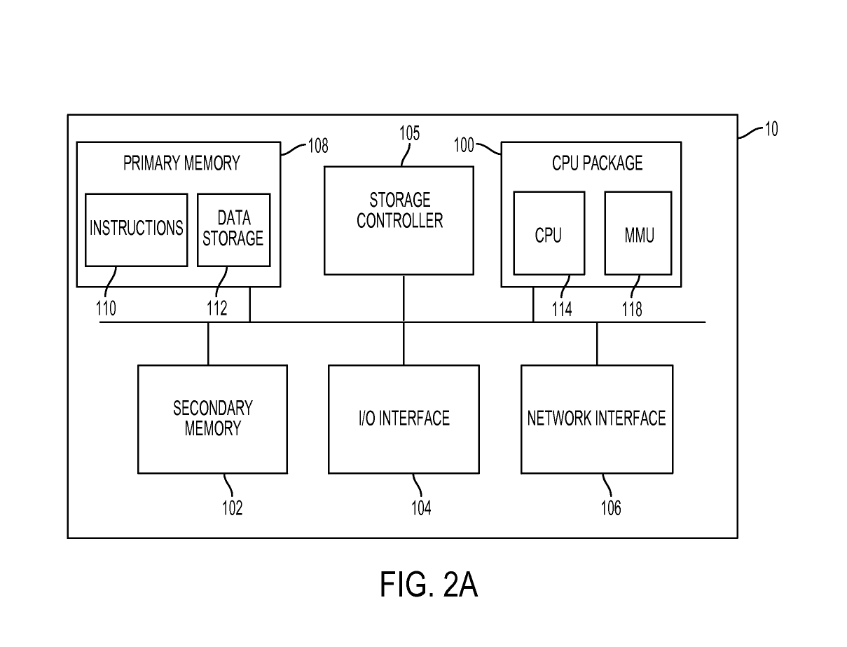

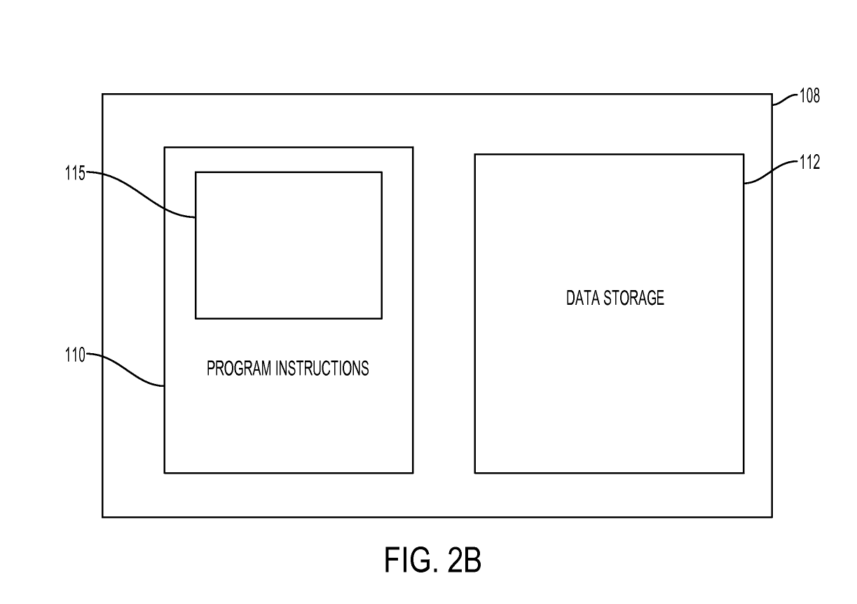

As described herein, a video content or asset 50 may be encoded into multiple streams or profiles 190 of video and/or audio content with varying bitrates. For example, the encoder may output five video streams, each at a bitrate of 0.2, 1, 3, 6, and 8 Mbps, which may correspond respectively to a resolution of 320×180p, 640×360p, 1280×720p, 1280×720p, and 1920×1280p. The varying bitrates may allow a client device 20 to accommodate different network conditions while streaming the video. Each encoded stream at a fixed bitrate/resolution may be referred to as a single profile 190. For example, each of the encoded streams may be an MPEG transport stream of a specific bitrate or resolution. Once encoded, each profile 190 may be further segmented, by a segmenting process, into multiple, contiguous file segments 150. The encoding and segmenting processes may be performed by server 10 or a different computing device or circuit. Each file segment 150 may be a multi-second portion of the stream or profile 190. For example, each file segment 150 may be a stream of 2 to 10 seconds long. In some embodiments, both video and audio are segments encoded such that each video profile 190 may contain both video and audio data. In some embodiments, the audio content may be separated from the video content, and is encoded to its own audio segments/profile. In some embodiments, each segment 150 may be further encapsulated and/or encrypted for secure transmission. Part or all of the file segments 150 may be further stored on a storage device (e.g. memory device 102, 112 of FIG. 2A or block storage device). The storage device 102, 112 may be installed on server 10, part of Data Store 40, or on a remote access server (not shown). A manifest file 120, as explained below, is configured to keep track of locations of all the file segments 150.

The segmenting process may also generate a manifest file 120. Manifest 120 may be modified by server 10. Manifest 120 may contain link or URI to each file segment 150 of a video profile 190 of a video asset. Manifest 120 may optionally include metadata regarding the video profile 190. In one embodiment, a manifest 120 may be created for each profile 190 of a video asset. In one embodiment, a master manifest file may be further created to keep track of all the profile-specific manifests 120.

Users may be associated with various client devices (or simply “client” for ease of reference) 20, such as mobile phones, smart phones, computing devices (e.g., a laptop), tablets, wearable devices (e.g. a smart watch), Internet of Things devices, and so on. Users may operate these client devices 20 to interact with server 30, for example, to submit a request for video streaming, to receive video content, to playback received video content in real-time or near real-time, and so on. Client 20 may monitor bandwidth and other network conditions based on a plurality of factors, and automatically determine a certain threshold of video quality and bitrate to be streamed based on the network conditions. For example, client 20 may determine that the currently available maximum bitrate is 1 Mbps and request fragments below this bitrate by transmitting command requests. Client 20 then may be configured to request a manifest file 120 from server 10, and based on the URIs in the manifest 120, proceeds to request, receive and/or download the appropriate file segment 150. Client 20 may determine the appropriate file segment 150 based on a naming convention that is mutually understood or pre-defined (e.g. “segment2of5.MPEG.part”). Client 20 may thus be configured to switch between streaming different file segments of varying video quality based on a detected or determined bandwidth or network conditions. Client 20 may automatically adapt, in real-time or near real-time, to fluctuations in a user's network.

For ABR streaming, the downloading and playback of multimedia on client 20 may be simultaneous or concurrent: a client 20 may first download a sufficient amount of data, begin playback of the video/audio, and during playback of the downloaded data, request the next segment of video/audio based on determined bandwidth conditions and measured network throughput. Client 20 can use heuristics to determine the appropriate wait times between checking for network conditions. Client 20 may monitor one or more of the following network conditions in order to determine the most appropriate bitrate of streaming video segment. Example network conditions include latency, jitter, packet loss rate, total throughout, speed, and so on. Server 10 may also monitor network conditions and determine the most appropriate video segment bitrate to be streamed, instead of or in conjunction with client 20. Server 10 is operable to register and authenticate users (using a login, unique identifier, and password for example) prior to providing access to digital data, a local network, network resources, other networks and network security devices. The user may be associated with a profile including specific video and network factors such as video quality and bitrate that may be used by client 20 or server 10 for video processing.

For simplicity only one computing device or server 10 is shown but system may include more computing devices to access remote network resources and exchange data. The server 10 may include a storage controller or circuitry to implement the storage and read/write process described herein. The computing device or server 10 may be the same or different types of devices. The server 10 may include at least one processor, a data storage device (including volatile memory or non-volatile memory or other data storage elements or a combination thereof), and at least one communication interface to connect and control storing and read/write of digital data to the storage device. The computing device components may be connected in various ways including directly coupled, indirectly coupled via a network, and distributed over a wide geographic area and connected via a network (which may be referred to as “cloud computing”). For example, and without limitation, the server may be a computing device, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

Network 30 may be any network capable of carrying data for the ARB streaming including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Data store 40 may be comprised of non-transitory computer-readable media storing various elements of information, such as user profiles, video information, network or data constraints, heuristic information, client requests, historical data, analytic data, event data, sensory data, and so on. The information may be stored in various formats, such as flat files, database records, spreadsheets, etc. Data store 40 may be a relational database. Data store 40 may include storage device controlled by storage controller.

FIG. 2A shows a schematic diagram of a computing device that may be used to implement the server 10 of FIG. 1, exemplary of an embodiment. As depicted, computing device 10 includes at least one CPU package 100, primary memory 108, secondary memory 102, at least one I/O interface 104, and at least one network interface 106. Computing device 10 also includes storage controller 105 to control the storing, and reading/writing to storage devices (e.g. primary memory 108, secondary memory 102) and scanning thereof according to some example embodiments.

Storage controller 105 may be configured for scanning, writing, reading, copying, or erasing digital data from the physical block. Storage controller 105 may have some form of a processor embedded into a controller. As a result, a storage controller 105 may be responsible for performing control functions for the storage system. The controller 105 may be configured to operate by itself (single controller), in a redundant pair (dual controller), as a node within a cluster of servers, and so on. Storage controller 105 has an I/O path to communicate to the storage network or servers, an I/O path that communicates to connected storage devices. Storage controller 105 has a processor (e.g. CPU 100 or another processor) that handles the scanning, writing, and reading of data as well as other data-related functions. Storage controller 105 may connect with multiple disk drives and communicate with each of these for scanning, reading, writing, and erasing as described herein.

CPU package 100 may include at least one processor or CPU 114 and at least one Memory Management Unit (MMU) 118. Each processor 114 may be, for example, any type of general-purpose microprocessor or microcontroller, a digital signal processing (DSP) processor, an integrated circuit, a field programmable gate array (FPGA), a reconfigurable processor, or any combination thereof. The processor 114 may be configured to determine video quality and bitrate for video/audio playback for server 10. Processor 114 may include or be integrated with storage controller 105 to implement one or more concatenation operations described herein. MMU 118 may be a hardware unit, or a unit comprising both hardware and software. In one embodiment, CPU 114 may call (via storage controller 105) upon MMU 118 to access a physical block on a storage device for the purpose of scanning, writing, reading, copying, or erasing digital data from the physical block. For example, MMU 118 may be configured to translate virtual memory address to physical addresses, and vice versa, on storage devices such as primary memory 108 or secondary memory 102. In some cases, MMU 118 may be configured to handle the moving of information between primary memory 108 and secondary memory 102. In one embodiment, MMU 118 may be installed separately from CPU package 100.

Primary memory 108, also known as RAM, may include a first storage portion 110 that stores program instructions and a second storage portion 112 that stores other types of data. Primary memory 108 may be directly accessible to the CPU package 100 by means of a memory bus (not shown). Primary memory 108 may be an example storage device according to some embodiments.

Secondary memory 102, also known as auxiliary memory, may be one or more non-volatile memory devices such as flash memory, optical discs, magnetic discs and magnetic tape. In one embodiment, secondary memory 102 may comprise at least one block storage device comprised of a plurality of physical locks 130. A single physical block 130a may include one or more physical addresses. In one embodiment, a single physical block may have a block size of x bytes, where each byte of data has a corresponding physical address. In some embodiment, each physical address may also correspond to a virtual memory address. Secondary memory 102 may be an example storage device according to some embodiments.

In one embodiment, primary memory 108 and secondary memory 102 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Each I/O interface 104 enables device 10 to interconnect with one or more input devices, such as a keyboard, mouse, camera, touch screen and a microphone, or with one or more output devices such as a display screen and a speaker. Storage controller 105 may interact with I/O interface 104 to scan.

Each network interface 106 enables device 10 to communicate with other components, to exchange data with other components, to access and connect to network resources, to serve applications, read/write data and perform other computing applications by connecting to a network (or multiple networks) capable of carrying data, e.g., one more networks 30. For example, storage controller 105 may connect with external storage devices via network interface 106.

FIG. 2B shows a simplified block diagram of a primary memory 108, on which various programs, including the optimization instructions 115 to increase data storage efficiency are stored (and accessed by storage controller 105). The optimization instructions 115 may contain program instructions, when executed by the processor 114 or storage controller 105, significantly reduce internal fragmentation caused by the storage of a large number of file segments 150 on a block storage device, increasing the efficiency factor of storage and/or read/write. This may optimize storage or throughput, for example. In some cases, the optimization instructions 115 may increase the efficiency factor to a number close to 100%. Such an optimization instructions may also be named a Concatenator process, as further described herein.

In one embodiment, parallel processing may be utilized. For example, a separate process (or thread or CPU core) may be utilized to perform the optimization process 115 on each profile 190 concurrently.

### Data Efficiency Factor

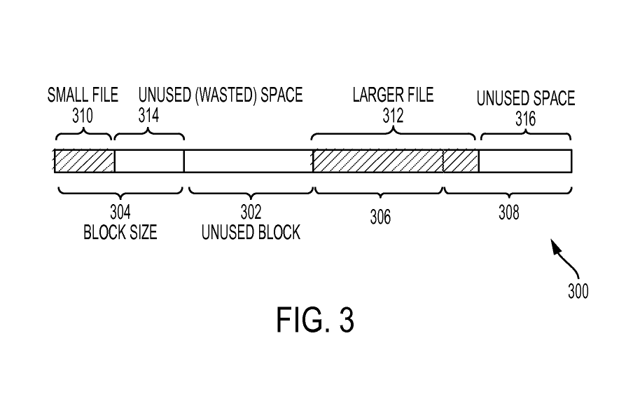

Internal fragmentation of storage devices may lead to low storage efficiency. This may also lead to low read/write efficiency. For example, FIG. 3 illustrates a schematic diagram of a portion 300 of a block storage device according to some embodiments. Four storage blocks are shown, including an unused block 302 and three blocks 304, 306, 308 storing a small file 310 that is smaller than the block size, and a large file 312 that is larger than the block size with unused storage space 314, 316 resulting from internal fragmentation. As shown, some or all of the multiple blocks on the storage device fail to be utilized, resulting in a low data storage efficiency, as described herein. The unused wasted space may lead to low storage and/or read/write efficiency.

The optimization instructions 115 may trigger calculation by processor 114 or storage controller 105 of an Efficiency Factor based on the following illustrative example:

$$Efficiency Factor = \frac{average block size}{storage block size}$$

For example, audio streams may be encoded, segmented, packaged and stored separately. Typical audio bit rate including overhead may be, for example, approximately 300 Kbps, and the audio file segment duration may be 2 seconds. If the block size on the storage device is 1 megabyte, the calculated Efficiency Factor is only 7.5%.

Each file segment 150 (FIG. 1) may be stored in multiple blocks. An average block size may be calculated as follows:

$$average block size = \frac{\begin{matrix}number of full blocks per segment + \\ block size + partial block size\end{matrix}}{number of blocks per segment}$$

where the segment size is the streaming bit rate multiplied by segment duration.

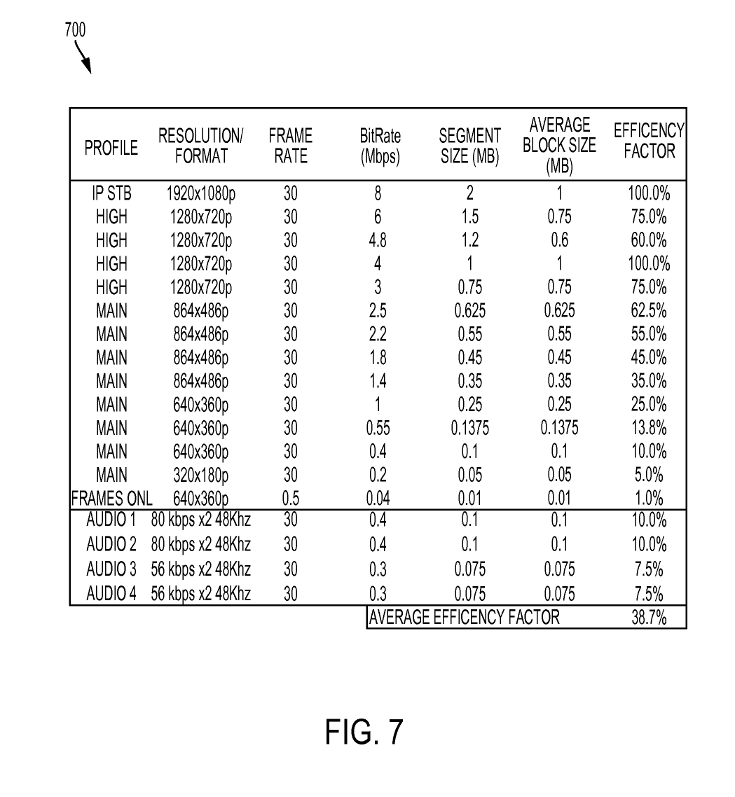

FIG. 7 shows an example video and audio ABR table 700 and the corresponding calculated efficiency factor for each profile, as well as the total average efficiency factor, which is 38.7% in this illustrative example. This table assumes a typical segment duration of 2 seconds, and a block size of 1 MB by way of illustration.

The embodiments described herein provide a method, system and device for reducing internal fragmentation caused by the storage of a large number of small files on a block storage device. In some example embodiments the improved storage device and method may increase the efficiency factor to close to 100%.

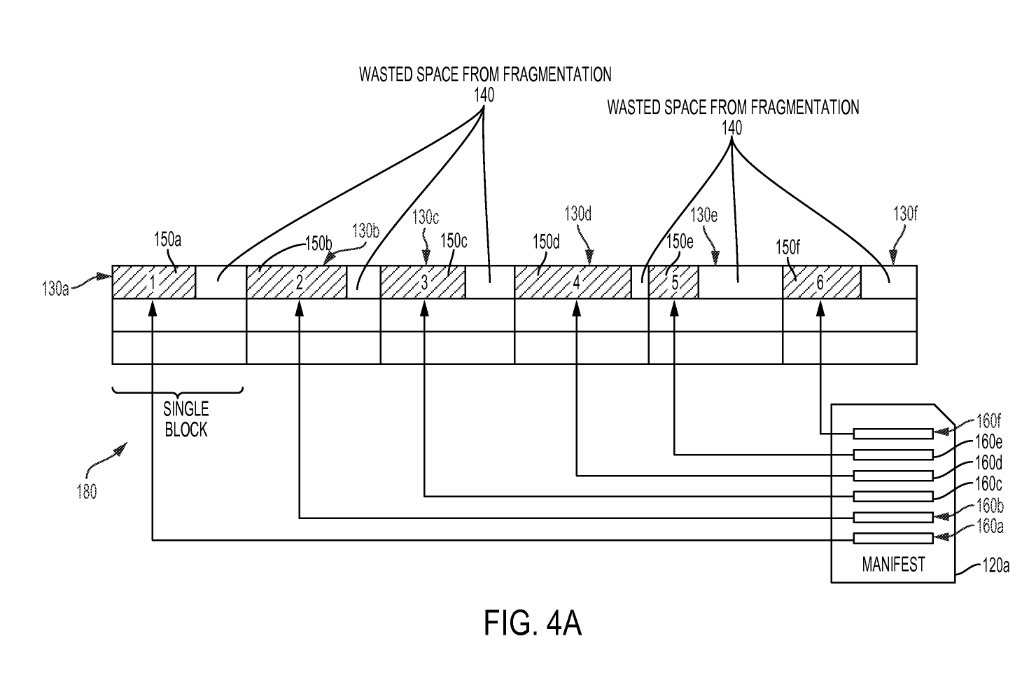

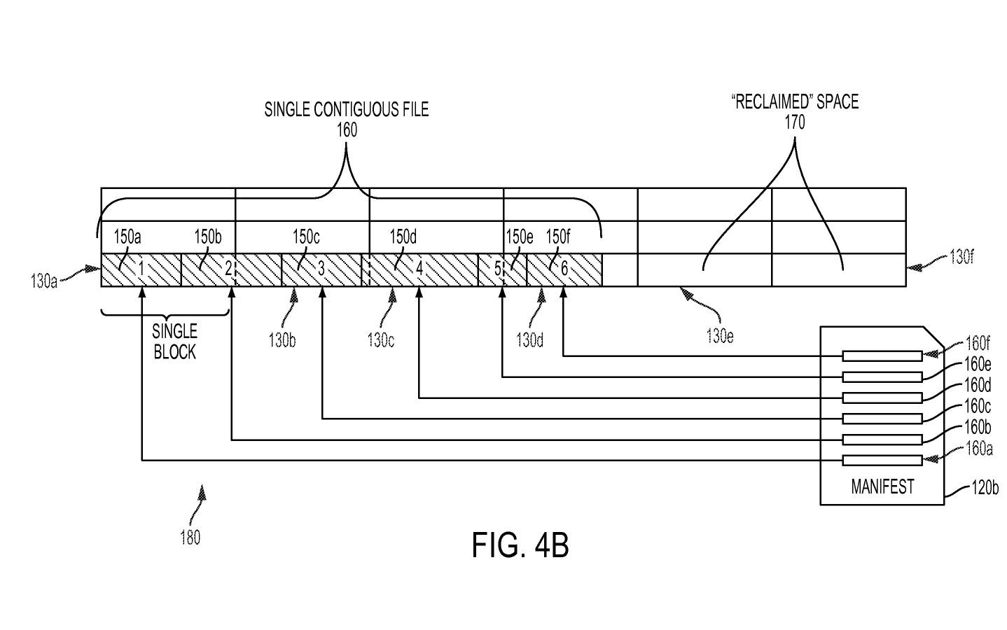

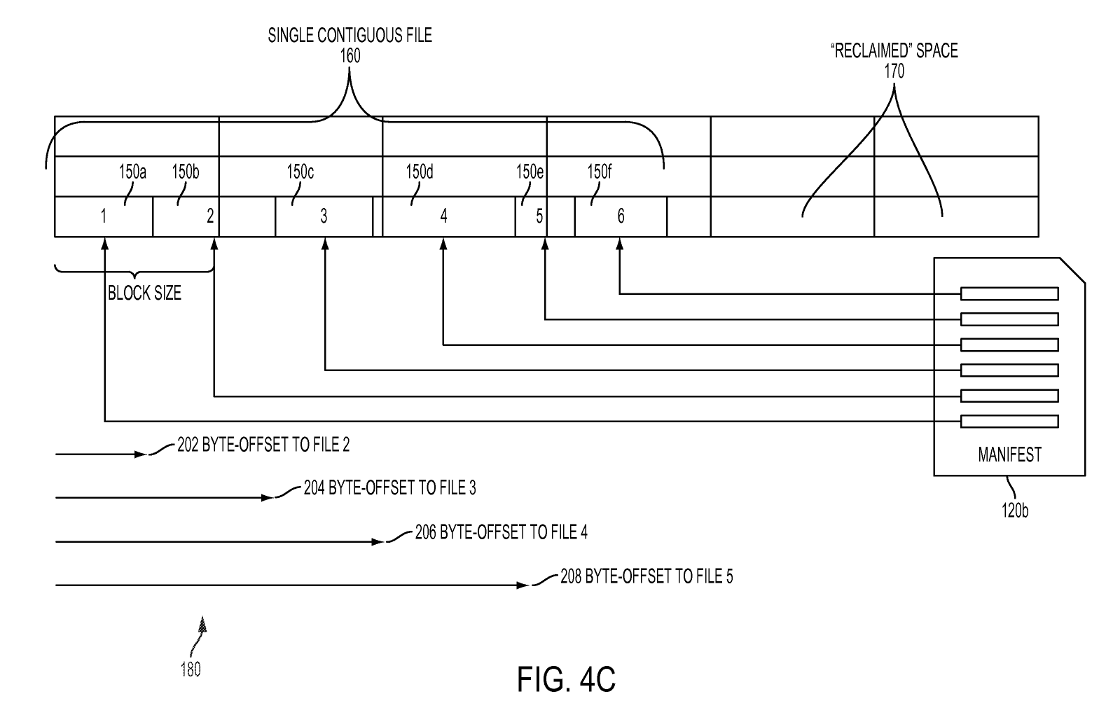

FIG. 4A illustrates a collection of individual file segments (noted as file segments 1 to 6 150a, 150b, 150c, 150d, 150e, 150f) that are stored on a portion (i.e., six blocks 130a, 130b, 130c, 130d, 130e, 130f) of a block storage device 180, prior to storage controller 105 (or other processor) applying an optimization process 115 to improve data storage efficiency. A manifest file 120a may reference or link to each stored file segment 150a, 150b, 150c, 150d, 150e, 150f by a URI 160a, 160b, 160c, 160d, 160e, 160f. A client 20 may download each segment 150 by following the corresponding URI 160 in the manifest 120a. Even though the file segments 1 to 6 150a, 150b, 150c, 150d, 150e, 150f are shown to be stored on six contiguous blocks 130a, 130b, 130c, 130d, 130e, 130f in a consecutive order on the storage device 180, each of the file segments 1 to 6 may be stored at a random location on the storage device, spaced apart by a number of blocks. As shown, each file segment 150a, 150b, 150c occupies a single block 130a, 130b, 130c on its own, resulting in wasted space 140 from internal fragmentation which may lead to storage, read/write and computing inefficiencies. There may be other devices or processors that do the writing and storage controller 105 is an illustrative example.

FIG. 4B illustrates a schematic diagram of the portion of block storage device in FIG. 4A after data storage optimization by storage controller 105, exemplary of an embodiment. FIG. 4B shows the resulting storage device 180 after the optimization process (by storage controller 105) and the resulting modified manifest 120b. A single contiguous file 160 created by the optimization process 115 uses only 4 storage blocks 130a, 130b, 130c, 130d, generating two storage blocks 130e, 130f of reclaimed space 170. Accordingly, the optimization process 115 results in reclaimed space 170 which may be obtained from concatenating the contents of multiple file segments 150a, 150b, 150c, 150d, 150e, 150f into one contiguous file 160. The new manifest 120b may reference a byte-offset or byte range value of the file segments 150a, 150b, 150c, 150d, 150e, 150f within the new contiguous file 160 for the video profile 190. The byte-offset or byte range value may update the URI 160a, 160b, 160c, 160d, 160e, 160f of the manifest 120b to reference the file segments 150a, 150b, 150c, 150d, 150e, 150f within the new contiguous file 160. The storage controller 105 (concatenator) calculates the byte offset and moves the blocks via read and write operations. Storage controller 105 determines length or size of file segments (e.g. bytes) to calculate offsets.

FIG. 4C shows the contiguous file 160 and byte offsets used to reference the moved file segments 150a, 150b, 150c, 150d, 150e, 150f. All references (e.g. URIs) in the manifest 120b may point to file 1 150a, but a reference to file 2 150b would add a byte-offset 202 from the beginning of file 1 150a that is equal to the length of file 1 150a, since file 2 150b immediately follows file 1 150a, Similarly, a reference to file 3 150c uses the URI pointing to file 1 150a with a byte offset 204 that is the sum of the lengths of files 1 and 2 150a, 150b. A reference to file 4 150d uses the reference or URI pointing to file 1 150a with a byte offset 206 that is the sum of the lengths of files 1 and 2 and 3 150a, 150b, 150c. A reference to file 5 150e uses the URI pointing to file 1 150a with a byte offset 208 that is the sum of the lengths of files 1 and 2 and 3 and 4 150a, 150b, 150c, 150d.

In accordance with an aspect, there is provided an optimization process 115 to improve data storage and read/write efficiency of block storage devices. The optimization process 115 in one embodiment does not modify existing workflows for creating video content, such as ABR content (e.g. thousands of small file segments); it can be applied after content is already stored and thus increase storage efficiency on existing content irrespective of when the content was stored. The optimization process 115 may be compatible with most playout protocols for ABR streaming so that no modification is needed to existing workflows in order to take advantage of the increased efficiency.

The optimization process may be a implemented by storage controller 105 (or another processor, device or circuit) that scans the physical storage device for separate file segments 150 that constitute a single video profile 190, and concatenates them into a single, contiguous file 160 per profile using read, write and erase operations. This reduces the total number of files and the fragmentation resulted from having many files stored. In addition, in order to allow the content to be played back, the manifests 120 that refer to the individual file segments 150 may be modified to refer to each segment in the contiguous file 160.

In one embodiment, as the storage controller 105 or concatenator scans the physical storage device for separate file segments 150 that constitute a single video profile 190, the storage controller 105 may be configured to determine or otherwise obtain the playback order of a specific file segment 150b based on a file naming convention. For example, the file segment 150b may be the second segment in the profile to be played, and its name may be “Segment2of5.MPEG.part”. Based on this playback order, the storage controller 105 process may reassemble the file segments into a single, contiguous file 160 per profile and store the file 160 on storage device 180.

In one embodiment, a video asset may be transcoded into five video profiles 190, each with a different bitrate, and each profile may be concatenated into a single contiguous file 160. Each concatenated file 160 may be comprised of sequential file segments 150 that are stored in its original playback order.

A manifest 120 for a profile 190 may also be updated by the server 10 or storage controller 105 to specify the appropriate location of each file segment 150 (of the single contiguous file 160) as stored on the storage device 180 by the concatenator or storage controller 105. For example, the manifest 120 may be modified to refer to a byte offset or a byte range value, based on a base address, which may be the starting address of the first file segment 150a of the single contiguous file 160. For example, the starting address may be in the form of a memory address. For example, the memory address may be a virtual memory address or a physical memory address. So, the client 20 may request the specific file segment 150a based on a byte range request that is part of a HTTP request. The HTTP request may pinpoint a file segment 150a by stipulating a byte range request of the entire contiguous file 160 to be returned by the server 10. The byte range request may for example include a starting offset value and/or a quantity. This may require that the HTTP server 10 sourcing the content and the playback device playing the content support byte-range requests. For example, standard HTTP protocol (e.g. RFC 7233) may accept byte-range requests.

For example, a typical byte range request may appear as follows:

GET/BigVideo_320×180.mpeg

Connection: keep-alive

Accept-Language: en-GB,en-US,en

Host:localhost:8080

Range: bytes=64312833-64657026

Accept: */*

If-Range: A023EF02BD589BC472A2D6774EAE3C58

User-Agent: Mozilla/5.0 (Windows NT 5.1) AppleWebKit/535.7 . . . .

Referer: http://localhost:8080/BigVideo_320×180.mp4

Accept-Encoding: identity

Accept-Charset: ISO-8859-1, utf-8,*

A typical response from the HTTP server to the byte-range request may appear as follows:

### 206 Partial Content

Content-Type: video/mpeg

Connection: keep-alive

Last-Modified: Wed, 14 Jul. 2015 15:50:59 GMT

ETag: A023EF02BD589BC472A2D6774EAE3C58

Transfer-Encoding:

Content-Length: 344194

Accept-Ranges: bytes

Server: Brisket/1.0.1

Date: Wed, 14 Jul. 2015 16:11:25 GMT

Content-Range: bytes 64312833-64657026/64657027

In one embodiment, the storage controller 105 may be part of the original process that writes the file segments 150 on storage device 180, such that the segments 150 are written in storage contiguously to start with. This approach may use a similar concatenation process, except that in deployment a single storage device may be used to store multiple streams from multiple different programs at the same time. Therefore, the incoming files are not naturally ordered contiguously as they were in the source. This storage controller 105 reorders the files back to their original contiguous order irrespective of what order they arrive in.

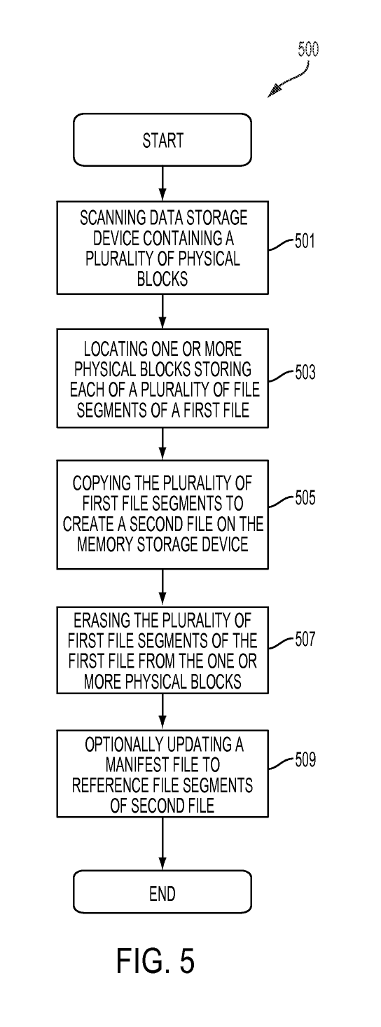

FIG. 5 is a flow chart illustrating an example optimization method, or concatenator process 500 that may be performed by the server 10 in FIG. 1 or storage controller 105 in FIG. 2, exemplary of an embodiment. At step 501, the storage controller 105 may be configured to scan data storage device 180, which may comprise a plurality of physical blocks, the data storage device 180 storing a plurality of original file segments belonging to a first profile 190.

At step 503, storage controller 105 may be configured to determine or locate one or more physical blocks 130 storing each of the plurality of original file segments 150. The storage controller 105 may be configured to, for example, call upon the CPU to look up and access each file segment by its name.

At step 505, storage controller 105 may be configured to copy the plurality of located file segments to create a second file 160 on the at least memory storage device, the second file 160 comprising new file segments stored on one or more contiguous physical blocks, each new file segment corresponding to a respective original file segment 150. At this stage, the storage controller 105 may read the original file segments from the initial physical storage blocks and write the original file segments to a number of contiguous physical storage blocks on the storage device to create a second file. The second file contains new file segments that are a concatenation of the original file segments. The number of contiguous physical storage blocks is less than the number of initial physical storage blocks to reduce wasted space and increase efficiency for storage. This also increase read/write efficiency. For example, the storage controller 105 may execute HDD reads that read more than just the requested data and will read past and cache that content in fast memory. If that data is accessed soon after, it is read from the cache, rather than from the hard drive. If the storage controller 105 collects data into contiguous streams on disk, it may improve cache utilization and hence read throughput. The storage controller 105 may also be able to improve write speeds by aggregating the files into fast storage, such as SSDs, and then writing it out using the concatenator onto the HDD in large, contiguous blocks, thus minimizing disk head motion and hence improving write throughput.

At step 507, the storage controller 105 may be configured to erase the plurality of original file segments of the first file from the one or more physical blocks 130 to free up additional free storage space.

Optionally, at step 509, where the first file may be associated with a manifest file stored on a server, the storage controller 105 may update the manifest file 120 by indicating a byte offset value associated with each new file segment of the second file. At this step, the storage controller 105 may determine or calculate the size of length of each of the initial file segments to calculate the byte offset values for updating the manifest file 120.

In one embodiment, the first file and the second file are a video or audio file, and the new file segments may be physically stored in such a way that the video or audio file is played back by sequentially accessing the one or more contiguous blocks.

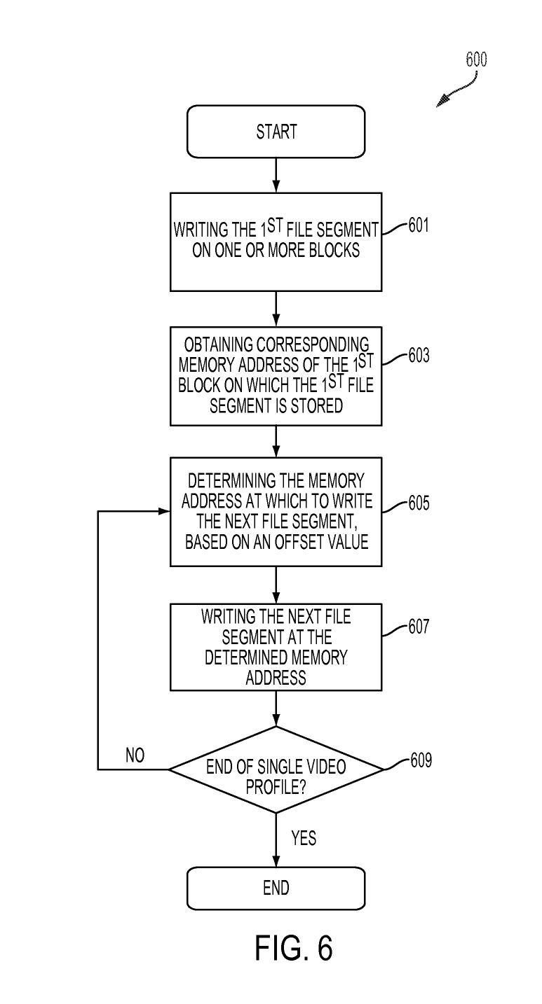

FIG. 6 is a flow chart illustrating an example data writing routine that may be performed by the server 10 as part of the data storage optimization method of copying a plurality of file segments of a first file or profile 190 to create a second file 160.

At step 601, the storage controller 105 may write a first file segment on one or more physical blocks of a storage device. At step 603, the storage controller 105 may obtain the corresponding memory address of a first physical block on which the first or previous file segment is stored. At step 605, the storage controller 105 may determine or obtain the memory address at which to write the next file segment based on a byte offset value. The byte offset value may be calculated using the size or length of the previously stored file segments, as noted in relation to FIG. 4C. At step 607, the storage controller 105 may write the next file segment at the determined memory address. The storage controller 105 may repeat steps until all file segments of the first file or profile have been copied over to the second file at step 609.

In one embodiment, the storage controller 105 may obtain the memory address of the first block at which the first file segment is stored by making an inquiry to the CPU, which in turn may make an inquiry to MMU, which manages the content of the data storage device and can map a physical address on a block storage device to a virtual memory address.

In some embodiments, the byte offset value may be based on a file size of the next or previous file segment(s). In one embodiment, the memory address at which to write the next file segment may be a virtual memory address or a physical memory address. In some embodiment, the storage controller 105 may concatenate and store each of the video and audio profiles separately into a contiguous file. In another embodiment, the storage controller 105 may concatenate and store multiple video and audio profiles into a single contiguous file.

In one embodiment, the storage controller 105 may be part of an ABR ingest process for storage of video assets. That is, immediately after segmenting the encoded video profiles 190, the concatenator or storage controller 105 may be configured to save all the file segments 150 right away into contiguous physical blocks 130 on data storage devices 180, as if all the segments 150 of a single profile 190 were consecutive parts of a single contiguous file saved on the storage device.

In another embodiment, the storage controller 105 may run the concatenation process after the file segments have already been saved onto the data storage device in a random manner. The storage controller 105 may be run at any appropriate time or as needed. For example, it may be configured to run after the file segments have been played one or more times by a client 20. It may be configured to run at least an hour after the ABR storage has been completed.

The storage controller 105 may be configured to concatenate video and audio data from multiple video assets, to concatenate video and audio data from multiple users, to concatenate video and audio data from the different copies of the same asset, to concatenate video and audio data from different copies of the same video asset in Cloud DVR use cases, to run on any type of block storage device, including magnetic tape, spinning disk, flash memory, or others.

The storage controller 105 or concatenator process may be configured to modify the manifests or index files for HLSv4, in which video and audio data may be muxed together or separately. The storage controller 105 or concatenator process may be configured to be used for private copies of assets for users. The storage controller 105 or concatenator process may be configured to be used for shared copies of assets.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only. The scope is indicated by the appended claims.

What is claimed is:

1. A storage system for adaptive bitrate video:
at least one memory storage device containing a plurality of physical storage blocks storing video and audio content encoded into multiple profiles, each profile segmented into a plurality of original file segments as a first file;
a storage controller configured to:
scan the at least one memory storage device to locate a number of initial physical storage blocks for the streaming video content;
read the plurality of original file segments from the number of initial physical storage blocks;
write the plurality of original file segments to a number of contiguous physical storage blocks to create a second file as a plurality of new file segments being a concatenation of the plurality of original file segments, each new file segment corresponding to an original file segment, the number of contiguous physical storage blocks being less than the number of initial physical storage blocks, and the number of contiguous physical storage blocks having less wasted memory space than the wasted memory space of the number of initial physical storage blocks;
write offset values for the plurality of new file segments to a manifest file stored on a server that links to the contiguous physical storage blocks; and
a network interface connected to the storage controller to stream the video content using an adaptive bitrate protocol to a plurality of client devices using the plurality of new file segments and the manifest file.

2. The storage system of claim 1, wherein the storage controller erases the plurality of original file segments of the first file from the one or more physical blocks.

3. The storage system of claim 1, wherein the first file is associated with the manifest file stored on the server, the manifest file having, for each of the plurality of original file segments, an initial pointer to the respective original file segment on an initial physical storage block of the number of initial physical storage blocks, and wherein the storage controller updates the manifest file with, for each new file segment of the second file, a byte offset value to update the initial pointer for the original file segment to the corresponding respective new file segment.

4. The storage system of claim 1, wherein the second file is a video or audio file, and the new file segments are physically stored in such a way that the video or audio file is played back by sequentially accessing the one or more contiguous blocks.

5. The storage system of claim 1, wherein the storage controller writes the plurality of original file segments to create a second file by:
writing a first file segment on one or more physical blocks;
obtaining corresponding memory address of a first block on which the first file segment is stored;
determining or obtaining the memory address at which to write the next file segment, based on a byte offset value; and
writing the next file segment at the determined memory address.

6. The storage system of claim 5, wherein the storage controller determines the byte offset value based on a file size of an adjacent file segment.

7. The storage system of claim 6, wherein the memory address at which to write the next file segment is a virtual memory address or a physical memory address.

8. A process for optimizing memory storage efficiency of data, comprising executing on a processor the steps of:
scanning at least one memory storage device containing a plurality of physical blocks to locate a number of initial physical storage blocks of the plurality of physical storage storing a plurality of original file segments belonging to a first file, the first file for adaptive bitrate video the number of initial physical storage blocks having wasted memory space;
reading the plurality of original file segments from the number of initial physical storage blocks;
writing the plurality of original file segments to a number of contiguous physical storage blocks of the plurality of physical blocks on the at least memory storage device to create a second file, the second file a plurality of new file segments being a concatenation of the plurality of original file segments, each new file segment corresponding to an original file segment, the number of contiguous physical storage blocks being less than the number of initial physical storage blocks, and the number of contiguous physical storage blocks having less wasted memory space than the wasted memory space of the number of initial physical storage blocks; and
streaming the video content using an adaptive bitrate protocol to a plurality of client devices using the plurality of new file segments and the manifest file.

9. The method of claim 8, further comprising erasing the plurality of original file segments of the first file from the one or more physical blocks.

10. The method of claim 8, wherein the first file is associated with a manifest file stored on a server, the manifest file having, for each of the plurality of original file segments, an initial pointer to the respective original file segment on an initial physical storage block of the number of initial physical storage blocks, and the method further comprises updating the manifest file with, for each new file segment of the second file, a byte offset value to update the initial pointer for the original file segment to the corresponding respective new file segment.

11. The method of claim 8, wherein the second file is a video or audio file, and the new file segments are physically stored in such a way that the video or audio file is played back by sequentially accessing the one or more contiguous blocks.

12. The method of claim 8, wherein writing of the plurality of original file segments to create a second file comprises:
writing a first file segment on one or more physical blocks;
obtaining corresponding memory address of a first block on which the first file segment is stored;
determining or obtaining the memory address at which to write the next file segment, based on a byte offset value; and
writing the next file segment at the determined memory address.

13. The method of claim 12, wherein the byte offset value is determined based on a file size of the next file segment.

14. The method of claim 13, wherein the memory address at which to write the next file segment is a virtual memory address or a physical memory address.

15. A storage controller configured to:
access at least one memory storage device containing a plurality of physical storage blocks storing video and audio content encoded into multiple profiles, each profile segmented into a plurality of original file segments as a first file;
scan the at least one memory storage device to locate a number of initial physical storage blocks for the streaming video content;
read the plurality of original file segments from the number of initial physical storage blocks;
write the plurality of original file segments to a number of contiguous physical storage blocks to create a second file as a plurality of new file segments being a concatenation of the plurality of original file segments, each new file segment corresponding to an original file segment, the number of contiguous physical storage blocks being less than the number of initial physical storage blocks, and the number of contiguous physical storage blocks having less wasted memory space than the wasted memory space of the number of initial physical storage blocks;
write offset values for the plurality of new file segments to a manifest file stored on a server that links to the contiguous physical storage blocks; and
connect to a network interface to stream the video content using an adaptive bitrate protocol to a plurality of client devices using the plurality of new file segments and the manifest file.

16. The storage controller of claim 15, configured to erase the plurality of original file segments of the first file from the one or more physical blocks.

17. The storage controller of claim 15, wherein the first file is associated with the manifest file stored on the server, the manifest file having, for each of the plurality of original file segments, an initial pointer to the respective original file segment on an initial physical storage block of the number of initial physical storage blocks, and wherein the storage controller updates the manifest file with, for each new file segment of the second file, a byte offset value to update the initial pointer for the original file segment to the corresponding respective new file segment.

18. The storage controller of claim 15, wherein the second file is a video or audio file, and the new file segments are physically stored in such a way that the video or audio file is played back by sequentially accessing the one or more contiguous blocks.

19. The storage controller of claim 15, wherein the storage controller writes the plurality of original file segments to create a second file by:
writing a first file segment on one or more physical blocks;
obtaining corresponding memory address of a first block on which the first file segment is stored;
determining or obtaining the memory address at which to write the next file segment, based on a byte offset value; and
writing the next file segment at the determined memory address.

20. The storage controller of claim 19, configured to determine the byte offset value based on a file size of an adjacent file segment.

21. The storage controller of claim 20, wherein the memory address at which to write the next file segment is a virtual memory address or a physical memory address.
